(19) United States
(12) Patent Application Publication
(10) Pub. No.: US 2013/0262559 A1
(43) Pub. Date: Oct. 3, 2013

(54) SYSTEM AND METHOD FOR TRACKING USE OF PORTABLE OBJECTS

(71) Applicants: Grant S. Neerings, Charlotte, NC (US); Courtney Shrock, Spokane, WA (US)

(72) Inventors: Grant S. Neerings, Charlotte, NC (US); Courtney Shrock, Spokane, WA (US)

(73) Assignee: DIY MEDIA, INC., Seattle, WA (US)

(21) Appl. No.: 13/433,274

(22) Filed: Mar. 28, 2012

(51) Int. Cl. G06F 15/16

(52) U.S. Cl. 709/203

(57) ABSTRACT

A system and method for tracking social use of portable objects distributed over a computer-communications network including the generation of at least one portable object on a content management platform executing on at least one application server, the distribution of an inactive representation of the at least one portable object over the network to one or more network servers that are communicatively coupled to a plurality of end-user devices, each end-user device operative to execute one or more Clients, each end-user using the Clients to engage in interactions with an activated portable object associated with each inactive representation, the delivery of activation data to Clients after detection of an object activation event on an inactive representation, the monitoring of interactions between end-users and activated portable objects, and the storing of a record for each monitored interaction in a database communicatively coupled the application server.

### FIELD

The present disclosure relates generally to the field of social commerce, and in particular but not exclusively, relates to a system and a method for tracking social use of portable objects associated with multimedia content and distributed over computer networks.

### BACKGROUND

Electronic commerce on the Internet has become commonplace. Many merchants offer goods and services using web sites on the Internet, and an increasing number of consumers purchase goods and services on various Internet websites. In many cases, the electronic commerce transactions involve electronic content and physical goods. For example, many consumers purchase items such as books, compact disks (CDs) and digital video disks (DVDs) via the Internet. Increasingly, however, consumers are using the Internet to purchase electronic content such as information products, music or to gain access to web sites that provide news or entertainment stories.

More recently, the Internet is being used to engage in a wide variety of social networking between and among different individuals and online communities. When used by businesses to promote their goods and services to such individuals and online communities, this form of networking is called “social media marketing.” In many of these online social relationships, users share and identify recommended content for use and consumption by other users with similar interests, hobbies and/or backgrounds. It is this unique ability to share or “virally distribute” content with recommendations and referrals that now enables the Internet to be used as a highly social medium. Furthermore, this “viral” distribution capability can now be used advantageously by content promoters, such as performing artists, visual artists, video and film producers, and content distribution companies, to create creative works that can be circulated to a far greater number of prospects and partners than was possible previously with a distribution capability which was limited only to the content creator's current list of customers.

Current methods for achieving viral distribution of content focus on the use of electronic mail. Moreover, current methods for tracking the frequency and type of social use of content that are now possible with the viral distribution of content are limited. However, a significant opportunity and need exists for enhanced capabilities to dynamically monitor, record and analyze the various types of social uses and interactions consumers or other end users are engaging in with virally distributed content.

One current approach that is used to distribute applications of limited functionality involves “web widgets.” A web widget is portable software that can be installed and executed within a hypertext-markup-language web page by an end user that does not require additional compilation. The most commonly used web widgets are discrete applications of limited functionality that allow users to turn personal content into dynamic web applications which can be shared on virtually any website. Current web widgets are limited to executing certain discrete applications as on-screen tools. For example, they are currently used to display on-screen clocks, event countdowns, auction-tickers, stock market tickers, daily weather reports and flight arrival information.

Notwithstanding their useful role in these types of applications, current web widgets are not used as self-contained electronic commerce platforms. There is a significant and growing need for more robust and self-contained “portable objects” with enhanced capabilities that will enable content owners to derive greater benefits from the viral distribution of multimedia content by enabling them to efficiently monitor, record and analyze the frequency and types of social uses and interactions consumers are engaging in with portable objects which are used to demonstrate and/or promote such content, to exploit social media marketing trends more effectively, and to engage in various forms of electronic commerce directly with current and prospective customers over the Internet and over the rapidly growing number of mobile networks and associated mobile devices.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A is a block diagram illustrating an operating environment for a content management platform in an embodiment.

FIG. 1B is a block diagram illustrating an alternative operating environment for a content management platform in an embodiment.

FIG. 2A is a block diagram illustrating the components of a content management platform in an embodiment.

FIG. 2B is a block diagram illustrating the components of an application server used for hosting and executing a content management platform in an embodiment.

FIG. 2C is a block diagram illustrating the components of a network-based server in an embodiment.

FIG. 3 is a block diagram illustrating an object builder resource component used in a content management platform in an embodiment.

FIG. 4 is a block diagram illustrating a content management component used in a content management platform in an embodiment.

FIG. 5 is a block diagram illustrating a market management component used in a content management platform in an embodiment.

FIG. 6 is a flow chart illustrating a method for generating object and assigning object identifiers using a content management platform in an embodiment.

FIG. 7A is a flow chart illustrating a method for activating a portable object in an embodiment.

FIG. 7B is a continuation of the method for activating a portable object shown in FIG. 7A.

FIG. 8 is an illustration of an activated object in an embodiment.

FIG. 9 is an illustration of an activated object in an embodiment.

FIG. 10 is an illustration of an activated object in an embodiment.

### DETAILED DESCRIPTION

In the description to follow, various aspects of embodiments of portable objects and the computing and communication system which supports their ability to perform electronic commerce transactions will be described, and specific configurations will be set forth. Numerous and specific details are given to provide an understanding of these embodiments. The aspects disclosed herein can be practiced without one or more of the specific details, or with other methods, components, systems, services, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

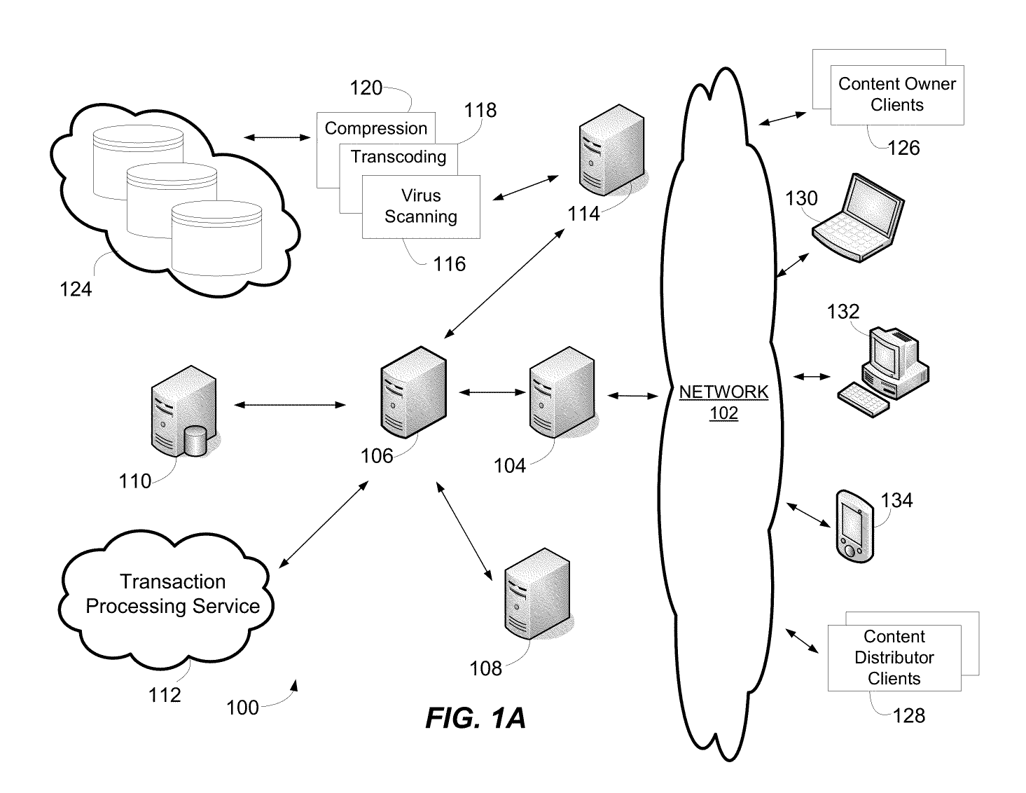

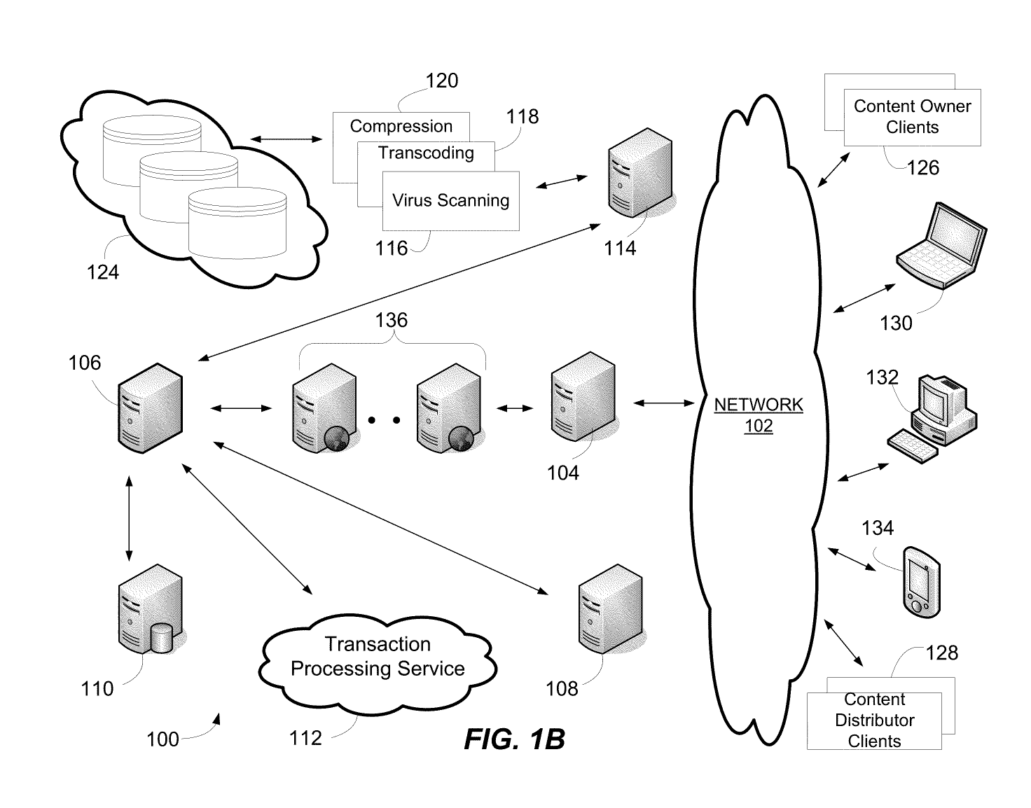

FIG. 1A is an illustration of an operating environment 100 for a content management platform in an embodiment. In this operating environment 100, one or more content distributor client devices 128, one or more content owner client devices 126, and one or more consumer client devices 130, 132, 134 are illustrated. Among the range of consumer client devices used for the distribution of multimedia content from the content management platform are laptop computers 130, desktop computers 132 and various types of mobile devices 134 such as personal digital assistants (i.e., PDAs) and tablet computers. As used here, the term “personal digital assistant” means both phone-enabled PDAs (i.e., smart phones) and non-phone enabled PDAs. Each of these client devices is communicatively coupled to a network 102 which provides secure computing and communications access through a server 104 executing a firewall software to an application server 106, which in this embodiment acts as a centralized compute processing and transaction management resource. In the illustrated embodiment, the network 102 is the Internet, a network of interconnected networks around the world which includes numerous network-based application servers. However, in other embodiments, the network 102 can be a private computer-communications network, a wireless communications network, or other computer data communications network that can enable the execution of applications on various network-based application servers and communications between and among computer devices, mobile devices, the content management platform and its infrastructure resources for storage and transaction processing.

The application server 106 is communicatively coupled to a database server 110, a transaction processing service 112, an email server 108 and a file management server 114. The file management server is communicatively coupled to one or more computing resources that perform file virus scanning 116, file transcoding 116 and file compression 120 for files which are stored on a cloud-based storage resource 124. In an embodiment, the database server 110 hosts a database that maintains a lookup table of all content files and related metadata which are stored on the cloud-based storage resource 124. This database also stores an object sharing table for the tracking of sharing events and other recorded social interactions. The file management server 114 is used to control the file conversion process from a first format in a received file to one or more transcoded formats. In an embodiment, a select subset of the transcoded files will then be compressed into a single file using file compression 120 and then stored on the cloud-based storage resource 124 along with related metadata for each file. In one embodiment, the files are compressed into a WinZip file for storage on the cloud-based storage resource 124. The email server 108 is used in an embodiment to facilitate electronic mail communications between and among content owners and content distributors, as well as email broadcasts to groups of consumers and prospects. In addition to its role in managing the use of resources in the content management platform, the application server 106 is also used for the creation of user account profiles, the execution of one or more web servers, and the execution of a content management system including an object builder resource component and a market management component. The web servers are used to receive and respond to content related requests received from consumer client devices 130, 132, 134.

In one embodiment, content owners using their client devices 126 upload, register in a lookup table stored on the database server 110, manage, package, price and create one or more compilations of stored and registered content for distribution to one or more consumer client devices 130, 132, 134 using compilation-specific objects that are created and capable of distribution from the application server 106. In creating objects, the application server 106 will search the lookup table stored on the database server 110 to confirm the availability and format of content files to be included in or associated with the objects. This process is also followed when new buttons, links or preview clips are created by content owners for subsequent distribution from the application server 106. The web servers executed on the application server 106 are used to respond to requests received from objects, buttons, links or preview clips executed or selected in browsers running on the consumer client devices 130, 132, 134. In an alternative embodiment, content owners upload content to the cloud-based storage resource 124 and the content management platform 200 registers information pertaining to the content in the database maintained on the database server 110. The content management platform 200 also executes a software service to update a schema of a search server to enable the search server to determine the locations of stored information in the database, to index the stored information, and to store a subset of the information in the search server to enable each activated portable object to use the search server to directly locate and retrieve the information pertaining to the content associated with each object without having to perform a conventional database search using a lookup table. The information pertaining to associated content includes but is not limited to the storage address of the content in the cloud-based storage resource 124, the owner-assigned names of content (e.g., names of musical selections, etc.) and pre-determined portions of content to be executed in an activated portable object to enable end-users to preview the content prior to purchasing or licensing the content. In this illustrated embodiment, the search server used by each activated portable object is the Apache Solr open-source search server built on the Apache Lucene™ text search engine library.

The content distributor client devices 128 are used by content distributors to provide content distribution feeds to update the content inventories of content owners with active accounts in the content management platform on the application server 106. These inventories can be updated with content from distribution feeds upon request of the content owners or the operators of the content management platform. In one embodiment, the distribution feeds provide content in bulk which is parsed by a content management system executed on the application server 106 to ensure that each content owner receives the content desired for inclusion in their respective content management systems. Each distribution feed is parsed and the content is allocated to each content owner's account as specified in the distribution feed. Once parsed, the content delivered in these distribution feeds is uploaded, master content files are transcoded to one or more alternative file formats pre-selected by content owners, the content files and their transcoded variants are stored in the cloud-based storage resource 124, and references to the stored content files and transcoded variants are registered in one or more lookup tables maintained on the database server 110. Once uploaded and registered on the database server 110, the content included in these distribution feeds can be accessed and used by content owners to create new content compilations for association with objects using an object builder resource component executed on the application server 106. In an embodiment, a content compilation is an aggregation of one or more multimedia content files and associated metadata. Once created and associated with specific multimedia content and related metadata, these objects are available for viral distribution by content owners to networks of current and potential consumers.

In one embodiment, the cloud-based storage resource 124 and the transaction processing service 112 are provided by the Amazon Web Services group at Amazon.com, Inc. More particularly, in the embodiment, the cloud-based storage resource is implemented using Amazon's “Simple Storage Service” (S3) which provides a data storage capacity that can be used to store and retrieve any amount of data, at any time, from anywhere on the World Wide Web. Likewise, in an embodiment, the transaction processing service 112 is implemented using Amazon's “Flexible Payments Service” (FPS) to facilitate the payment processing and checkout process once consumers decide to purchase and download content from virally distributed objects, buttons, links or preview clips. In this embodiment, the FPS is used to process payments from consumers who wish to purchase registered multimedia content promoted in virally distributed objects, buttons, links or preview clips using their credit cards, debit cards or bank account information. Furthermore, in an alternative embodiment, the file virus scanning 116, file transcoding 118 and file compression 118 processes are implemented using Amazon's “Elastic Compute Cloud” (EC2) resources instead of dedicated, proprietary servers. The EC2 is a web service that provides resizable compute capacity in a cloud-based network that can be scaled to provide computing capacity for applications serving multiple client devices.

Consumers using browsers executing on their client devices 130, 132, 134 can activate portable objects directly or indirectly. A portable object, referred to more generally as an “object,” can be activated indirectly if a consumer receives a button or link and then clicks on the button or link which results in the activation of an object. Likewise, a consumer can directly activate an object if it is received from the content owner or a third party who has opted to share or redistribute the object. Once activated, a consumer can opt to preview the content which has been packaged with the object, share the object with third parties or elect to purchase the multimedia content packaged with the object. If a consumer elects to purchase specific multimedia content files by clicking on an embedded buy button, then the object provides the consumer with a choice of format options and then redirects the consumer to the transaction processing service 112 for the provision of credit card, debit card or bank account information and completion of the purchase transaction. Once the purchase transaction is completed, the selected multimedia content files are downloaded by the object from the cloud-based storage resource 124 to the consumer's designated client device 130, 132, 134.

FIG. 1B is an alternative embodiment of the operating environment 100 of the content management platform. In this operating environment 100, one or more web servers have been added as independent computing resources for use in receiving and responding to content related requests from various client devices 130, 132, 134. This embodiment is computationally more efficient and enables the application server 106 to be dedicated to the operation of a content management system and the control of processes on the other servers used in this operating environment. As discussed above, these servers include an email server 108, a database server 110, a file management server 114, and control over a transaction processing service 112 and content conversion services for file virus scanning 116, file transcoding 118, and file compression 120 for storage in the cloud-based storage resource 124.

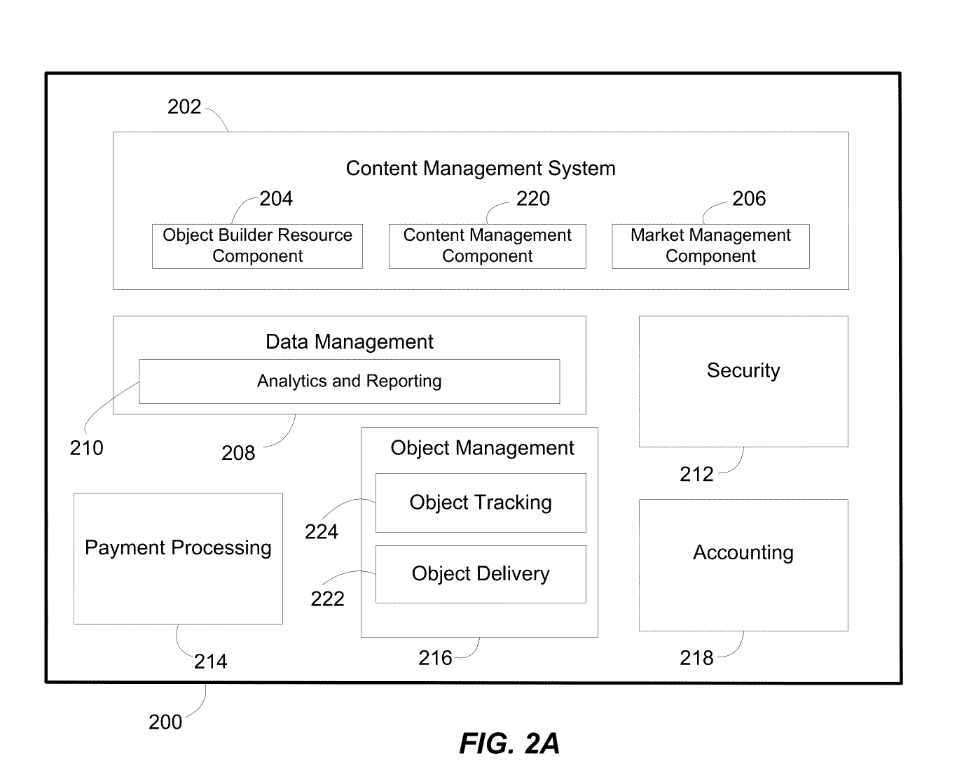

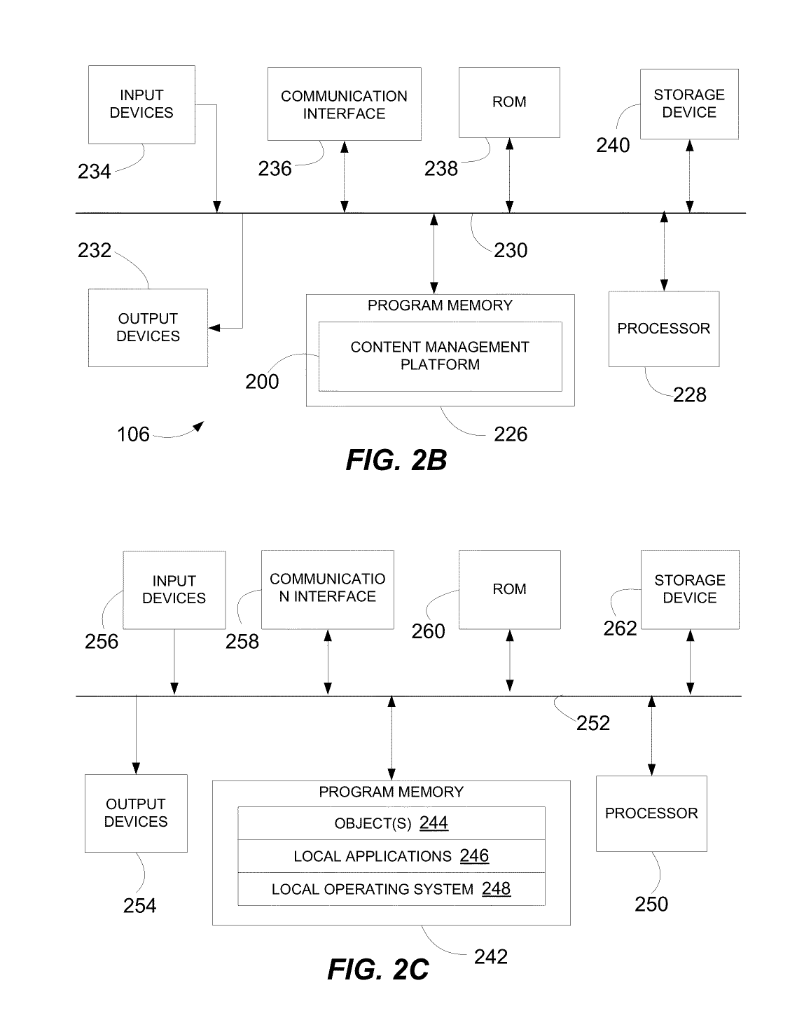

FIG. 2A is an illustration of an embodiment of a content management platform 200. In this embodiment, the platform 200 is comprised of a content management system 202, a data management service 208, an analytics and reporting service 210, a security service 212, a transaction payment processing service 214, an object management service 216, an object delivery service 222, an object tracking service 224, and an accounting service 218. The content management system 202 is comprised of three components, an object builder resource component 204, a content management component 220, and a market management component 206. The content management component 220 is used for the uploading of multimedia content, the editing of metadata related to the content and the creation of compilations of content into marketable packages that can be associated with one or more objects. In addition to controlling the uploading, editing and creation of content compilations through the content management component 220, the content management system 202 also controls the processes applied to uploaded content files for virus scanning, file transcoding and file compression for storage in the cloud-based storage resource 124. The object builder resource component 204 is used to create various marketing resources including new objects, buy buttons, links and preview clips. In one embodiment, the buy buttons, links and preview clips are each communicatively coupled to a object so that the selection or clicking on a button, link or preview clip causes the activation of an object Once these marketing resources are created, content owners will be enabled to use them in viral distribution marketing campaigns to promote their content compilations. The market management component 206 is used by content owners to assign market rules and pricing terms to selected items included in a content compilation. In one embodiment, the items include individual songs, song releases, or entire song catalogues. In a different embodiment, the items include reports, physical merchandising paraphernalia (e.g., cups, t-shirts, hats, etc.), and other electronic goods.

The data management service 208 is used to maintain a lookup table for use in tracking the locations of stored multimedia content files in the cloud-based storage resource, transcoded variants of these files, compressed files including one or more copies of content files and transcoded files, and files storing usage statistics collected by one or more web servers from the objects, buy buttons, links, preview clips or other marketing resources which are created and distributed by content owners and third parties. The analytics and reporting service 210 in one embodiment is a subcomponent of the data management service 208 and is used to analyze compiled analytical data, transaction statistics and location statistics for the marketing resources used by content owners in promoting their multimedia contents over one or more networks. More specifically, the analytics and reporting service 210 compiles transaction statistics and location statistics arising from the viral distribution of objects and related purchase transactions initiated and completed over objects which have been distributed over such networks. In an alternative embodiment, the analytics and reporting service 210 is a stand-alone service which independently interacts with the data management service 208 and the one or more web servers comprising the object management service 216 which are used for the tracking of objects and other marketing resources and the collection of usage statistics from these resources. In one embodiment, the statistics compiled by this service 210 are the number of sales, the number of times distributed objects have been viewed, the number of times the object has been shared, the location of the objects as determined from geography and internet protocol address, and the number of times distributed objects have made calls to the content management platform 200.

The security software service 212 provides content owners, distributor clients and consumer clients with secured access to the content management platform 200 and its operating infrastructure by implementing an authentication process to confirm that the credentials presented by a user (e.g., username and password) match a user identifier (a “UserID”) which is stored in the database maintained on the database server 110. The security service 212 also determines what functions, features and services an authenticated user is authorized to access. In one embodiment, firewall software is a component of the security service 212 and is used to restrict access to the application server 106 and other computing resources used as part of the operating environment for the content management platform 200. The payment processing service 214 provides direct access to transaction processing resources for the completion of purchase transactions initiated by consumers who use objects to preview, purchase and download multimedia content. An order identifier (an “OrderID”) is generated by the payment processing service 214 for each completed purchase transaction and all OrderIDs are stored in the object sales table which is in the database maintained on the database server 110. In one embodiment, the payment processing service 214 is provided by the Flexible Payment Service (FPS) offered by Amazon.com, Inc. The payment processing service 214 is used for the facilitation and execution of payment transactions using credit cards, debit cards or other bank account information.

The object management service 216 is implemented on one or more web servers and is used for the tracking of objects which have been distributed to and activated on Internet websites or on other accessible locations and resources over other networks. Once an object has been distributed or activated from a link, buy button or preview clip, it can be further distributed in a “viral” fashion to other online communities, websites, forums, etc. In one embodiment, the object management service 216 is implemented on web servers which are co-hosted on the application server 106. In an alternative embodiment, the object management service 216 is implemented on one or more independent web servers 136. In both embodiments, however, the object management service is used for receiving and responding to requests for multimedia content received from objects. In addition, the web servers implementing the object management service 216 also perform data collection and activity monitoring on deployed objects. The data collected by the web servers includes transaction statistics, location statistics, usage statistics and other pertinent market statistics for each object which has been created, activated and distributed over the Internet, mobile networks or other computer communication networks by the content owner or third parties, such as consumers and members of their online social networks. Once an object is activated, the web servers implementing the object management service 216 compile the data statistics into one or more files which are stored in the cloud-based storage resource 124 and a reference to the stored data collection files is created in the lookup table maintained by the data management service 208 and associated with the multimedia content files and any related transcoded files which have been packaged with each object for which the statistics have been collected. In an alternative embodiment, the one or more data collection files including the data statistics are stored in the database on the database server 110 where the lookup table is maintained by the data management service 208. The object management service 216 also implements an object tracking service 224 and an object delivery service 222. The object tracking service 224 performs the activity monitoring on deployed objects and, more specifically, it actively monitors users and their social interactions with deployed objects at each stage of activation for each object. Users engage in social interactions with activated objects using Clients (e.g., desktop browsers, mobile-device browsers, etc.) executing on User Devices (i.e., consumer client devices 130, 132, 134). The object tracking service 224 monitors user-object social interactions performed within the Clients (e.g., views, shares, recommendations, content purchase and license activity, etc.) compiles a data record of all social user interactions, records the compiled social user interactions as recorded events, and registers these events as nodes in an Action Graph for the purpose of recording each social interaction at each distinct generational level of interaction (e.g., sharing, recommending, etc.). Each node in the Action Graph is assigned a unique identifier called a NodeID. The object delivery service 222 delivers activation data to an activating object executing in a Client on a User Device after confirmation of the existence of an object and its associated content in the database maintained on the database server 110 that corresponds to the activating object executing on the Client. In one embodiment, the activation data includes the multimedia content files and related metadata required to enable full activation and operation of an object.

The accounting service 218 provides account transaction reconciliation for each content owner having an active account on the content management system 202. By using the accounting service 218, content owners can track the number and type of available content in their inventories of content files, the number of transactions performed relative to the total number of available content files, the number of transactions which have been returned for credit to consumers, the number of completed transactions, and revenue earned from completed transactions.

FIG. 2B depicts an embodiment of an application server 106 operative to execute the content management platform 200. This embodiment includes one or more input devices 234, a communication interface 236, a read-only memory 238, a storage device 240, a processor 228, a program memory 226 and one or more output devices 232. The program memory 226 in one embodiment is a random access memory. The storage device 240 in operative embodiments includes one or more floppy disks and conventional hard disks. The read-only memory 238 in operative embodiments includes one or more CD-ROMs, Flash ROMS and nonvolatile ROMs. Each of these components of the application server 106 is communicatively coupled to communication bus 230. Program memory 226 includes a content management platform 200. In an embodiment, the communication interface 236 is operative to receive calls, data transfer requests and content purchase requests from distributed objects (or other portable content distribution devices) and to transmit metadata and content to the distributed objects and devices for the previewing and downloading of content to client devices 130, 132, 134.

FIG. 2C illustrates the components of a network-based application server in the network 102. Similar to the application server 106 shown in FIG. 2A, this network-based application server is comprised of one or more input devices 256, a communication interface 258 that is operative to communicate with the application server 106, a read-only memory 260, a storage device 262, a processor 250, a program memory 242 and one or more output devices 254. The program memory 242 in one embodiment is a random access memory. The storage device 262 in operative embodiments includes one or more floppy disks and conventional hard disks. The read-only memory 260 in operative embodiments includes one or more CD-ROMs, Flash ROMS and nonvolatile ROMs. Each of these components is coupled to a communication bus 252 to facilitate inter-component communication. In one embodiment, the program memory 242 includes representations of one or more inactive objects 244, local software applications 246 and a local operating system 248. The network-based application server in one embodiment is a server used to operate social media platforms such as Facebook, Twitter, Flickr, Xing, Bing, etc. where users can create and post their own content. Thus, the local applications 246 in an embodiment are the applications required to execute a social media platform and the local operating system is the operating system required to enable the platforms to be fully operable on a network-based server.

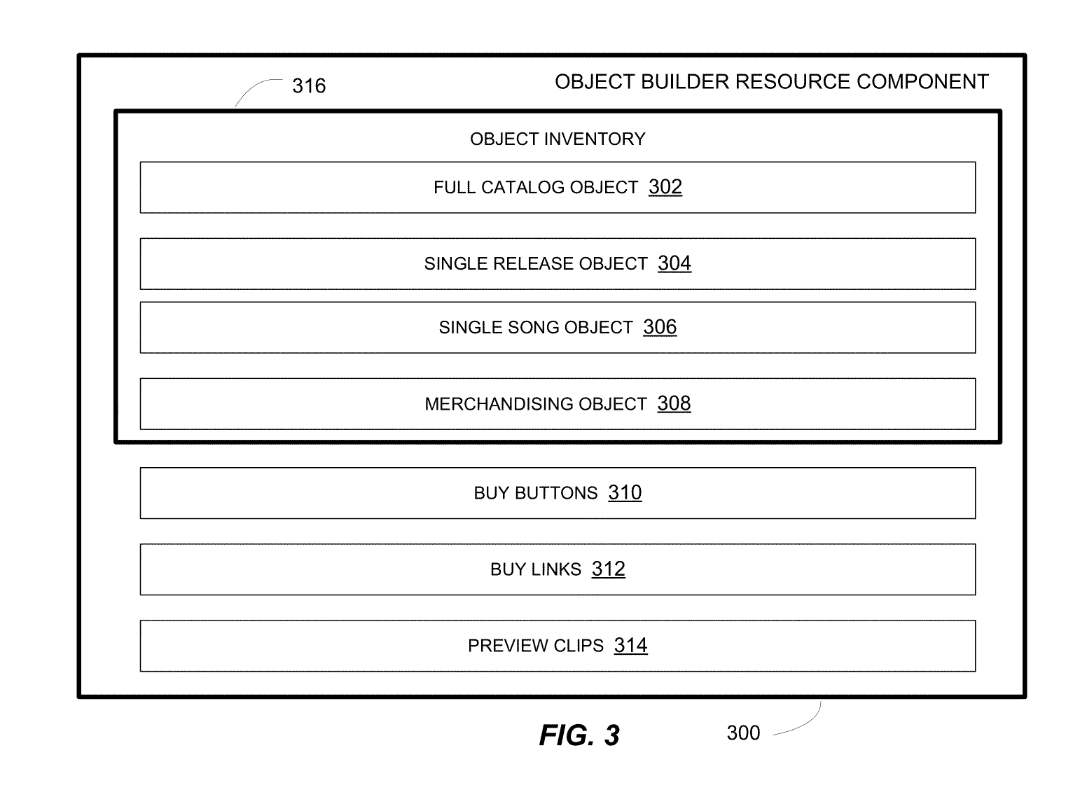

FIG. 3 depicts an embodiment of an object builder resource component. The object builder resource component 300 is used to create an inventory of “objects” 316, buy buttons 310, buy links 312 and preview clips 314. In an embodiment, the object inventory 316 includes services for creating objects for packages of marketable multimedia content including, in one embodiment, full catalogs of digital music content, single releases of digital music content and single song digital music content. The object builder resource component 300 is also used to create a merchandising object 308 to promote a content owner's physical goods and related materials as marketing merchandise. Examples of such physical goods are coffee mugs, t-shirts, hats, jackets, etc. In the present embodiment, the objects pertain to musical content which is often compiled in the form of musical catalogs, musical releases, and single songs. A full catalog object 302 is used for the promotion of the full musical catalog of a content owner. In one embodiment, the full catalog object 302 is used to execute a video clip that provides a preview of the content in a content owner's inventory in the content management platform 200 that is packaged with the object. The objects 302, 304, 306, 308 are also used to facilitate electronic commerce transactions involving the purchase or licensing of multimedia content, such as musical selections as shown in this embodiment, in the specific groupings desired (i.e., catalog, release, or single song).

A single release object 304 is used to promote a single musical release of a content owner from content stored in a content inventory of the content management platform 200 in an embodiment. A single song object 306 is used to promote a single song provided by a content owner in an embodiment. The merchandising object 308 is used to promote the merchandise or physical goods that a content owner may choose to promote alone or in association with one or more multimedia content files in an embodiment. The merchandising object 308 is used when a content owner seeks to create a fully custom content compilation which may include promoted merchandise or physical goods (e.g., cups, hats, t-shirts, etc.), a subset of content from specific releases as well as other content from the content owner's catalogue which is not included in any specific release. The buy buttons 310 are generated by content owners using the object builder resource component 300 and linked to objects. The buy buttons 310 can be customized and distributed to online resources on the Internet, on mobile communication networks or on other computer networks for use in promoting the various groupings of multimedia content available from a content owner. Once a buy button 310 is clicked or selected by a consumer, it will activate its linked object and take the consumer to a checkout screen in the object. The buy links 312 are Hypertext Transfer Protocol (HTTP) links that are created by content owners for widespread, viral distribution on the Internet, on mobile communications network or on other networks that enable consumers to click on such links to activate objects associated with these links that promote their multimedia content files and related merchandise. The preview clips 314 created in the object builder resource component 300 are linked to objects but are designed to automatically execute video and audio clips in the browsers of consumer client devices 130, 132, 134 to enable those consumers to preview multimedia content and to make informed choices about the multimedia content they may elect to purchase and download to their client devices 130, 132, 134, or to further distribute to third parties in the social networks of these consumers or in other online communities. Upon completion of an executing video clip, the linked object which will have been activated at the start of execution of the preview video clip will be displayed in the browsers of the consumer client devices 130, 132, 134 to aid the consumer in making a purchase or distribute decision.

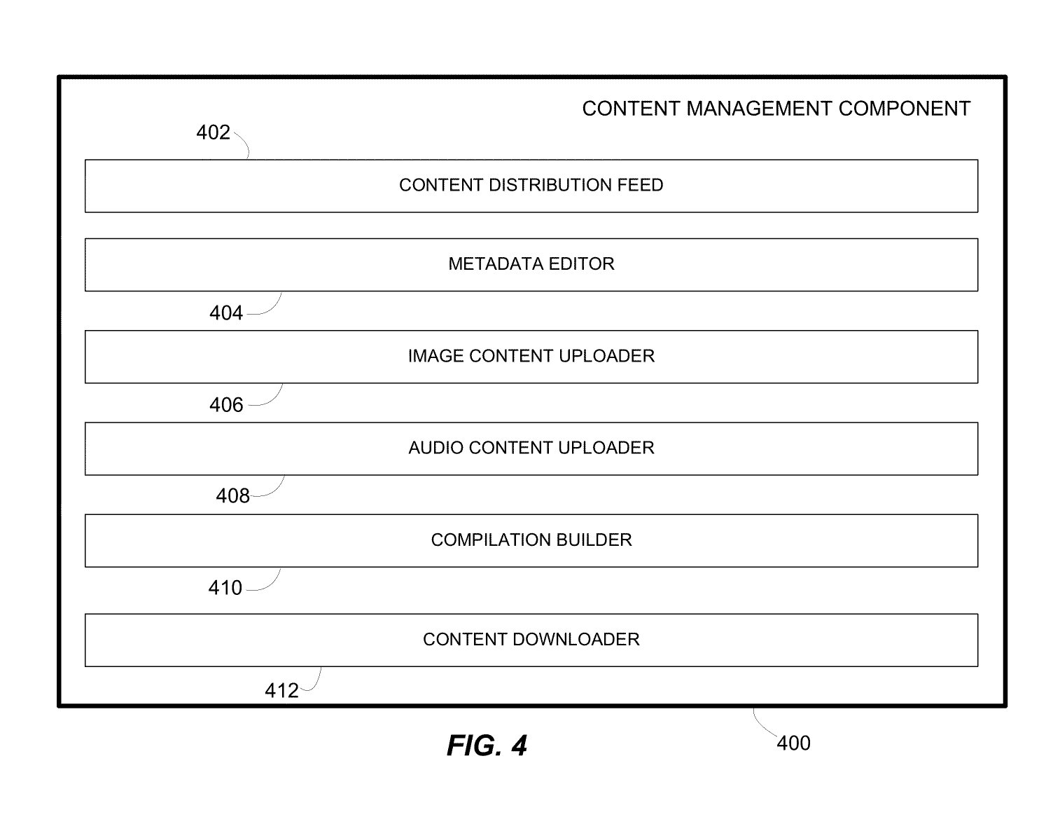

FIG. 4 illustrates an embodiment of a content management component 400. The content management component 400 is comprised of several services. The content distribution feed 402 is a service that enables content owners to request and receive distribution feeds from content distributors. The content provided by content distributors to content owners through such feeds is used to automatically update and supplement the content inventories of content owners in the content management system 202. The metadata editor 404 is a service that enables content owners to edit the metadata associated with multimedia content files. In one embodiment, the type of metadata that can be edited includes information pertaining to the musical content of a content owner such as title, artist name, release date, genres, catalogue number and Universal Product Code. Image Content Uploader 406 is a service that uploads, store and registers image files provided by content owners for use in creating marketable compilations of content associated with objects. In one embodiment the types of image files which can be uploaded using the Image Content Uploader 406 are GIF files, JPEG files and TIF files. Audio Content Uploader 408 is used for uploading audio files. In an embodiment the audio file types that can be uploaded using the Audio Content Uploader 408 include WAV files and MP3 files. The compilation builder 410 is used by content owners to create custom compilations from the content available in the content inventories managed by the content management system 202. In an embodiment, each content compilation created using the compilation builder 410 is associated with an object that will be distributed using the web distribution service 216 to consumers on the Internet, mobile communications networks, or other computer communications. Lastly, the content downloader 412 is used for controlling the downloading of the custom content compilations created by content owners which are packaged with and promoted through objects. Upon receipt of a content download request from an object, the content downloader 412 initiates and controls the process of retrieving the packaged content compilations associated with and promoted through the object from the cloud-based storage resource 124 or other storage in the content management platform 200, and it also controls the process of downloading the retrieved content compilations to a client device 130, 132, 134.

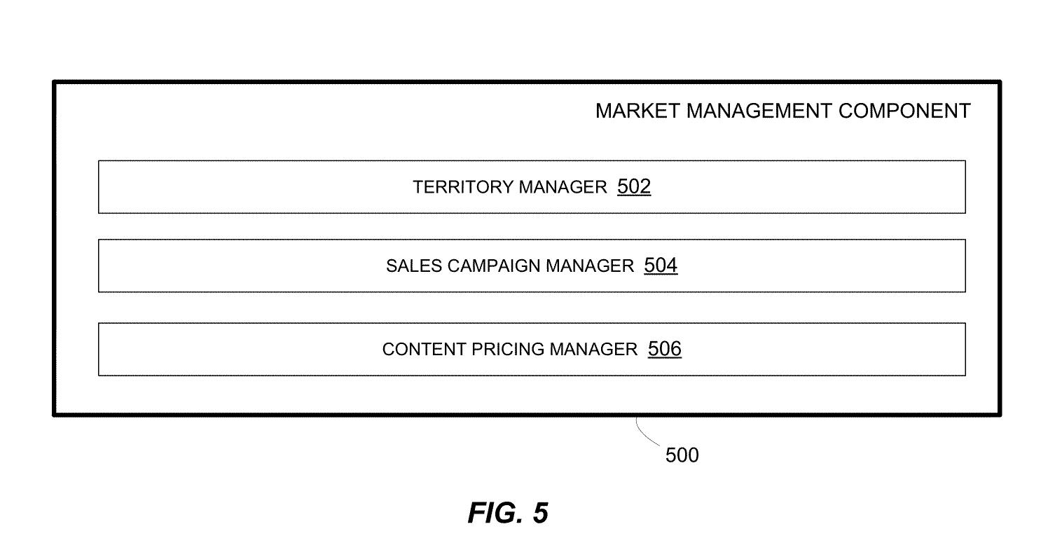

FIG. 5 illustrates the services provided in an embodiment of a market management component 500. As shown, one service is a territory manager 502 which is used by content owners to set the sales parameters and the timing of sales campaigns relating to specifically available content from a content owner in different geographic regions of the world. For example, a content owner may choose to provide a subset or only a particular release version of certain musical content for sales and marketing campaigns in Spain, Germany or France. While in other parts of the world, the content owner may choose to set different territorial restrictions on the availability of their content such as limiting the availability of musical content only to earlier releases rather than later releases in an entirely different part of the world, such as South America or in specific South American countries. The sales campaign manager 504 is another service provided in an embodiment of the market management component 500 that enables content owners to enable and disable sales campaigns by specified dates. The content pricing manager 506 is a service that allows content owners to set the pricing of particular files by file type. Although not limited only to musical content, in one embodiment the content pricing manager 506 is used to set pricing for MP3 file types and for WAV file types. Although the present embodiment is described with respect to the use of musical content stored in MP3 and .WAV file formats, the use of a content pricing manager 506 is not limited to the pricing of content for musical files or even to the pricing of files in these two types of file formats, but can be applied broadly to the pricing of content in image files, video files, audio book files, or video game files as well as in other file types and file formats of multimedia content generated by content owners.

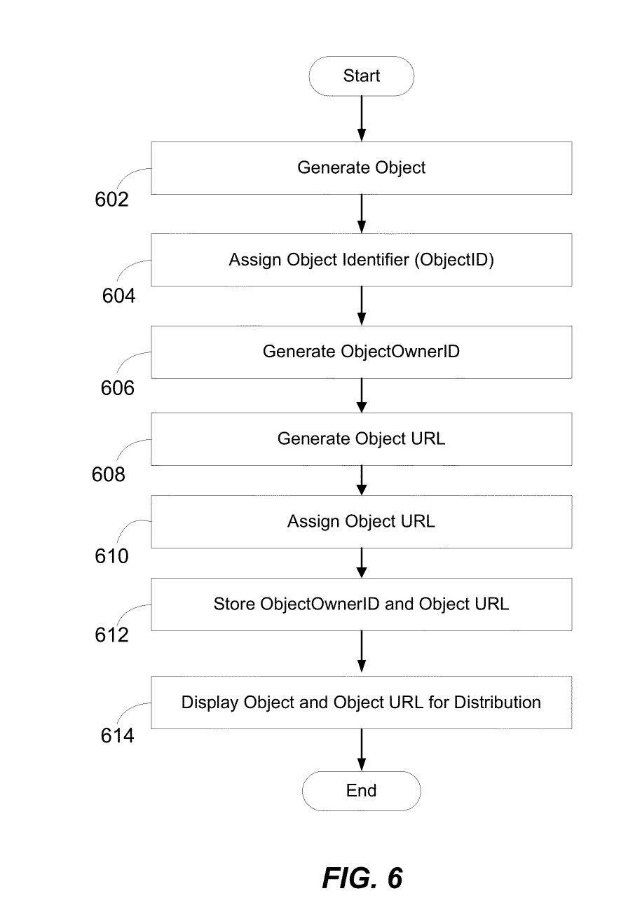

FIG. 6 is an illustration of a method used to generate new objects and to assign identifiers to the objects for tracking after distribution from a content management platform in one embodiment. As shown, this method begins with the generation of a new object at Step 602 which involves the identification and assignment of one or more types of content including multimedia content and multimedia representations of physical objects to be displayed within an object, and the storage of each newly generated object in the database maintained on the database server 110. Afterwards, an object identifier is assigned as shown at Step 604 to the new object and an Object Owner Identifier (ObjectOwnerID) is generated as shown at Step 606, which is a unique identifier used to identify the specific object which has been created with the associated content. An ObjectOwnerID is a unique identifier assigned to the person that generates a portable object using the content management platform 200. A Universal Resource Locator (URL) is generated for the object as shown at Step 608 and then the URL is assigned to the new object as shown at Step 610, which is referred to as the “Object URL”. The assigned Object URL is used in the distribution of the object to one or more Clients which are accessible over a computer network and to track the interactions between third party users and the object after distribution from the content management platform 200. The ObjectOwnerID and the Object URL are then stored in the database maintained on the database server 110, as shown at Step 612, and the newly generated object and its associated object URL are then displayed and made available for distribution by the content creator as shown at Step 614. A newly created object can be distributed in a number of ways including the copying and pasting of the new Object URL to one or more sites of interest on the Internet by the object owner or by copying and posting a graphical image of the object to various sites on the Internet or another computer network. In one embodiment, a content owner may distribute a new object by posting inactive “shells” (i.e., inactive representations of the object) onto various social networking sites such as Facebook Fan Pages, Twitter postings, postings on MySpace and on blogs or other social networking forums online. Additionally, the Object URL and representations of the newly created object (i.e., the inactive shells) are distributed and made accessible to mobile devices which provide access to Internet resources using mobile-enabled Clients.

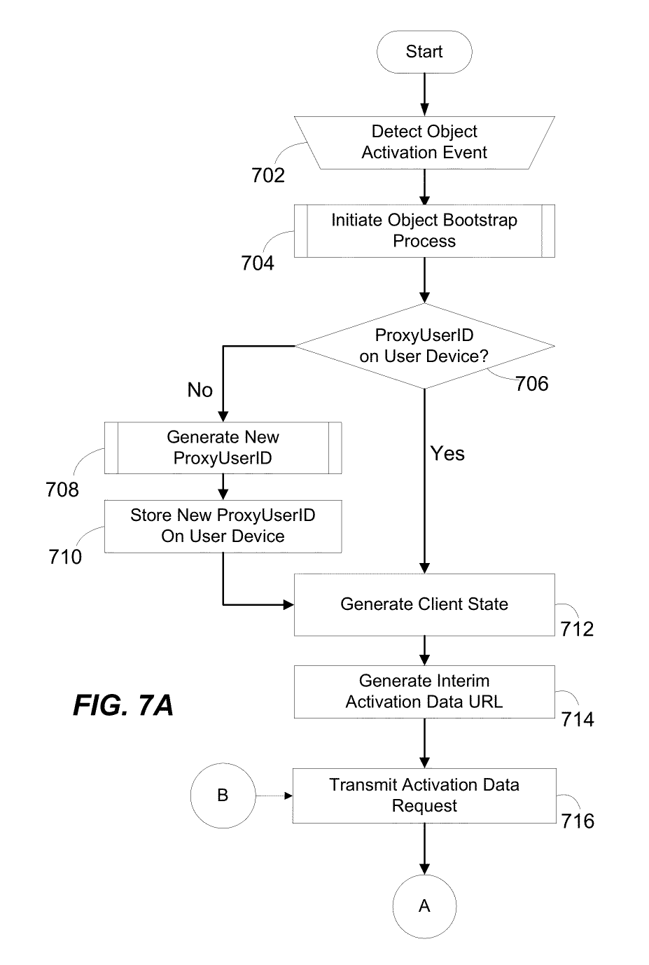

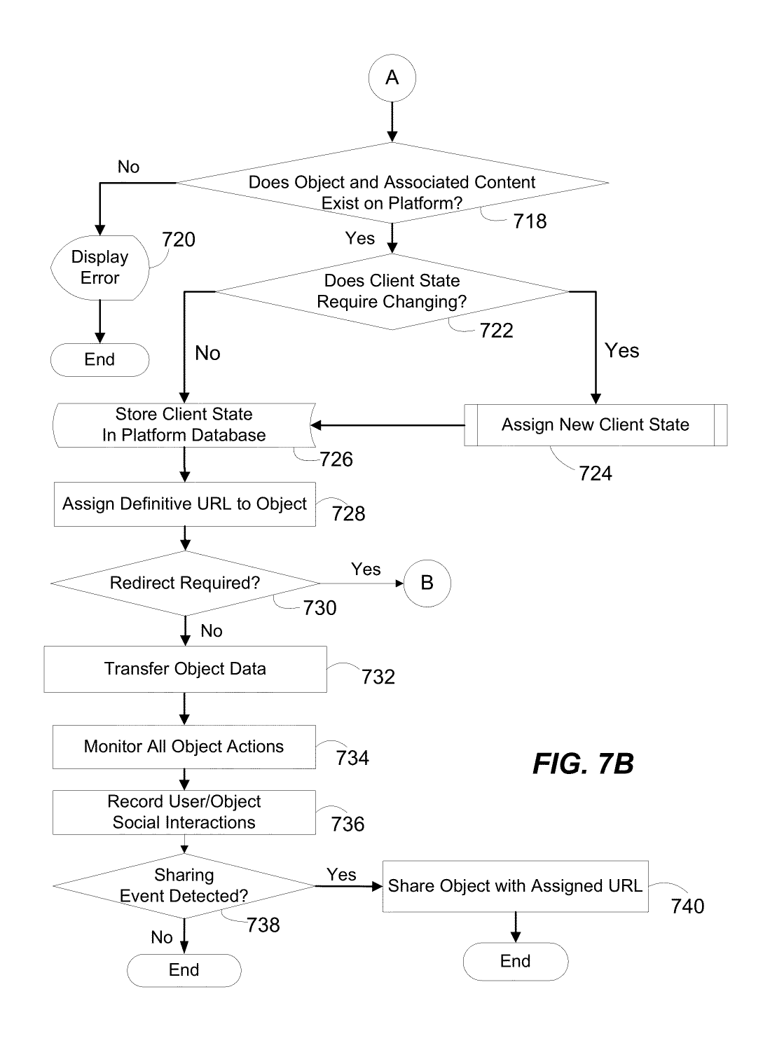

FIG. 7A is an illustration of a method performed for the activation of an object in one embodiment. This method begins with the detection of an object activation event as shown at Step 702. In one embodiment, an object activation event is a mouse click on a graphical image displaying a shell or graphical skin of an inactive object on a network resource such as Facebook page or website. In a different embodiment, the object activation event is the tapping on a graphical image displaying the shell or graphical skin of the inactive object on a touch-sensitive screen of a User Device. Upon detection of a mouse click or a tapping on the inactive object, the Client initiates an object bootstrapping process as shown at Step 704. This bootstrapping process will cause the Client to invoke an Object Container which includes software code for activating the object. The term “Object Container” means computer software code resident on a User Device that is used to execute one or more bootstrapping processes to enable the generation and execution of an activated object associated with the inactive representation of the inactive object. During the bootstrapping process, in one embodiment an activating object will be displayed based on a content stored in the local memory of a network server or in the cache of a User Device. A “User Device” is a computing device communicatively coupled to the computer-communications network 102 over which data is received and transmitted, and more particularly, this term includes the consumer client devices 130, 132, 134 illustrated in FIGS. 1A and 1B. More specifically, if a third party user interacts with an inactive shell of an object on a network server such as one used on a social network platform like Facebook or Twitter, then the Object Container and content file used for displaying a representation of an activating object will be retrieved from a local cache on the network server used with such social networking service. Alternatively, if a user has previously activated other objects, then an Object Container will have been previously stored on the User Device and this stored version of the Object Container will be invoked by the Client and used to perform the bootstrapping process to activate the object. During the bootstrapping process, the Object Container will perform a check of the memory of the User Device used in performing the activation event (i.e., used a user to click on or perform a selective action to activate an object) to determine if a Proxy User Identifier (i.e., a Proxy User ID) exists, as shown at Step 706. If a Proxy User ID exists on the User Device, then the boot strapping process will generate current client-state information, as shown at Step 712. In one embodiment, Client-state information is a collection of data characterizing the operating environment of a User Device and includes at least the following information: (i) the Client datetime, (ii) a User Agent identification string, and (iii) the Proxy User ID. After generating the client-state information (Step 712), the bootstrapping process will generate an Interim Activation Data Universal Resource Locator (URL), as shown at Step 714. The Interim Activation Data URL is the address used by an activating object to retrieve its activation data to enable full activation of the object. The activation data is provided to the object from an object delivery service 222 executed by the object management service 216 of the content management platform 200. In one embodiment, the Interim Activation Data URL includes a domain name, an Object Identifier (“ObjectID”), a Segment Identifier (“SegmentID”), and the newly generated client-state information. The ObjectID is a unique identifier assigned to each portable object generated using the content management platform 200. The SegmentID is a compressed and encoded representation of the Proxy User ID and a Node Identifier (“NodeID”). A NodeID is a unique identifier representing the collected set of data used to characterize a recorded event. In an embodiment, the recorded event is a new selection request to view the object and its associated content which was made at the time a user clicked on the inactive object. In alternative embodiments, a recorded event includes a sharing of an object, a recommending of an object to one or more third parties, a sampling of content accessed through the object, or even a purchase or licensing of content through the object.

A Node ID is generated on the content management platform 200 and includes an encoded representation of at least the following information: (i) a User Agent identification string, (ii) a current datetime on the User Device, (iii) the connecting internet protocol address (i.e., the IP Address) of the Client, (iv) the assigned Proxy User ID, and (v) an Event URL. A Node ID is maintained within the database maintained on the database server 110 and is stored as part of an Action Graph. An Action Graph is an abstract representation of the interaction relationships between different generational users of an active object expressed in terms of a directed graph where each object on the graph is a Node ID and each link in the graph represents a generational transition from one Node ID to the next in a sequential manner. In short, the node represents an association between an event and a Object URL at a certain time. After generation of the Interim Activation Data URL (Step 714), the bootstrapping process executed on the Client will initiate the transmission of an activation data request, as shown at Step 716. This data request is transmitted to the location specified in the Interim Activation Data URL and is the means by which an object on a Client will communicate with the object delivery service 222 to request and receive its activation data. The activation data is all content and related metadata associated with an object as stored in the database maintained on the database server 110 that can be displayed, streamed, sampled, previewed, purchased or licensed through the fully activated object executed on the Client.

Returning to Step 706, if the check performed by the bootstrapping process determines that no Proxy User ID is stored on the User Device, then a separate process will be initiated on the Client using software code implemented in the Object Container to generate a new Proxy User ID for the User Device, as shown at Step 708. Upon generation of the new Proxy User ID, it will be stored on the User Device, as shown at Step 710, and the process will proceed with the generation of the client-state information, as shown at Step 712, and the subsequent generation of an Interim Activation Data URL, as shown at Step 714. After generation of the Interim Activation Data URL, an activation data request will be transmitted as shown at Step 716 to the content management platform 200.

As used herein, the term “Proxy User ID” means a unique identifier used to identify a user of a User Device. It is produced from a repeatable computer-implemented process which uses available data from the operating environment of the User Device including but not limited to its Media Access Control address (i.e., MAC address) and data in its user agent header field. A user agent is software that acts on behalf of a user and is used in communications between a client and a server in distributed computing systems. In the hypertext transfer protocol which is used in the embodiments described herein for the transmission of activation data requests, a user agent identifies the client software originating the request using a “user agent header” to establish communications between a client and the content management platform 200 executing on one or more servers. The term “Client” as used herein means a software application executed on a User Device for retrieving, presenting and traversing information on the Internet and for activating and executing objects. In activating an object, the software application initiates a bootstrapping process to fully enable active operation of the object. One embodiment of a Client described herein is a web browser, such as the Internet Explorer browser, Opera browser, the Mozilla Firefox browser and the Google Chrome browser. In an alternative embodiment, a Client is mobile browser such as the Safari browser, the Opera mobile browser and the Polaris browser.

FIG. 7B continues the method shown in FIG. 7A. After receipt of the transmitted activation data request, as shown at Step 716, the content management platform 200 performs a check to determine if the object and its associated content exist on or can be accessed by the platform 200, as shown at Step 718. If the object does not exist on the content management platform 200, then a display error will be returned to the Client and an error message will be shown on the Client, as shown at Step 720. Alternatively, if the object and associated content do exist on the content management platform 200, the object management service 216 will confirm whether the client-state information requires changing, as shown at Step 722. As discussed previously, the client-state information is a collection of data characterizing the operating environment on the User Device and includes encoded information representing the Client datetime of the Node origination (i.e., the date and time of a new recorded event which has been marked with a NodeID and associated in an Action Graph), the User Agent identification string and the Proxy User ID. If the Proxy User ID which is retrieved or generated by the Client and received by the object delivery service 222 from the activation data request is not identical to the Proxy User ID associated with the object that is stored on the content management platform 200 and related to the object on which the third party user performed an object activation event, then a new Proxy User ID will be generated on the content management platform 200 and included in newly assigned client-state information. Likewise, if the NodeID or ObjectIDs are inconsistent or differ from the NodeID or ObjectID for the associated object that is stored on or accessible from the content management platform 200, then the client-state information will be re-generated and assigned to the object with an updated and corrected ObjectID, or an updated and corrected NodeID, as applicable. After assignment of the new client-state information, as shown at Step 724, the client-state information will be stored in a database accessible from the content management platform 200, as shown at Step 726, and a final, definitive URL will be assigned to the object (the “assigned URL”), as shown at Step 728. The definitive URL assigned to an object differs from the Interim Activation Data URL and is assigned to an fully activated object that will be displayed on the Client after (i) confirmation of the existence of an object and associated content on the content management platform 200, and (ii) updating of one or more elements of the client-state information. Upon assignment of a definitive URL, the object delivery service 222 of the content management platform 200 will confirm whether an address redirection is required, as shown at Step 730. A redirect will be required if the definitive URL generated for the object differs from the Interim Activation Data URL received at the time of the activation data request. The two URLs will differ if new client-state information is to be assigned to an object, such as when the Proxy User ID included in the client-state information provided in the Interim Activation Data URL is not identical to the Proxy User ID included in the definitive URL.

If both the Interim Activation Data URL and the definitive URL are the same, then the object data enabling full activation of the object will be transferred to the Client, as shown at Step 732, and all actions of the object will be monitored continuously by the object tracking service 224, as shown at Step 734. In monitoring the actions of an object, the object tracking service 224 will store a record of each user-object social interaction, as shown at Step 736. User-object social interactions include, in one embodiment, the viewing, sharing, recommending, purchasing or licensing of content accessible through the object by third party users. A sharing social interaction (referred to as a “sharing event”) entails, in one embodiment, a distribution of an inactive representation of an object to each Client executing on each User Device used by each of the third party users. In an alternative embodiment, the sharing event entails posting of an inactive representation of an object or its assigned URL in online communities, online forums, online blogs or in electronic mail messages. Each social interaction will be monitored and a record will be created and stored in an effort to determine the range of social interactions involving the object at each point in its social use. These interactions will be associated with NodeIDs in an Action Graph stored in the database maintained on the database server 110 to generationally track each significant social interaction between users of objects. Sharing statistics pertinent to the generationally use of objects will be compiled from the data tracked by the object tracking service 224 and stored and analyzed on an ongoing basis by the data management service 208 of the content management platform 200. If a sharing event (or other social interaction) is detected, as shown at Step 738, then the shared object will be shared with the assigned URL, as shown at Step 740. If no sharing event is detected during a monitoring period used by the object tracking service 224, then the process will conclude.

Alternatively, if the object delivery service 222 of the content management platform 200 determines that a redirect is required, as shown at Step 730, based on the assignment of new client-state information (Step 724), then the Client will be sent a re-transmission request message along with updated URL information. Once received by the Client, an activation data request will be re-transmitted to the content object delivery service 222 on the content management platform 200 using the updated URL, as shown at Step 716. The process in FIG. 7B is performed again and once the content management platform 200 determines that the client state information does not require changing and that a redirect is not required, the object delivery service 222 of the content management platform 200 will proceed with the transmission of activation data to the Client to enable full activation and execution of the selected portable object in the Client.

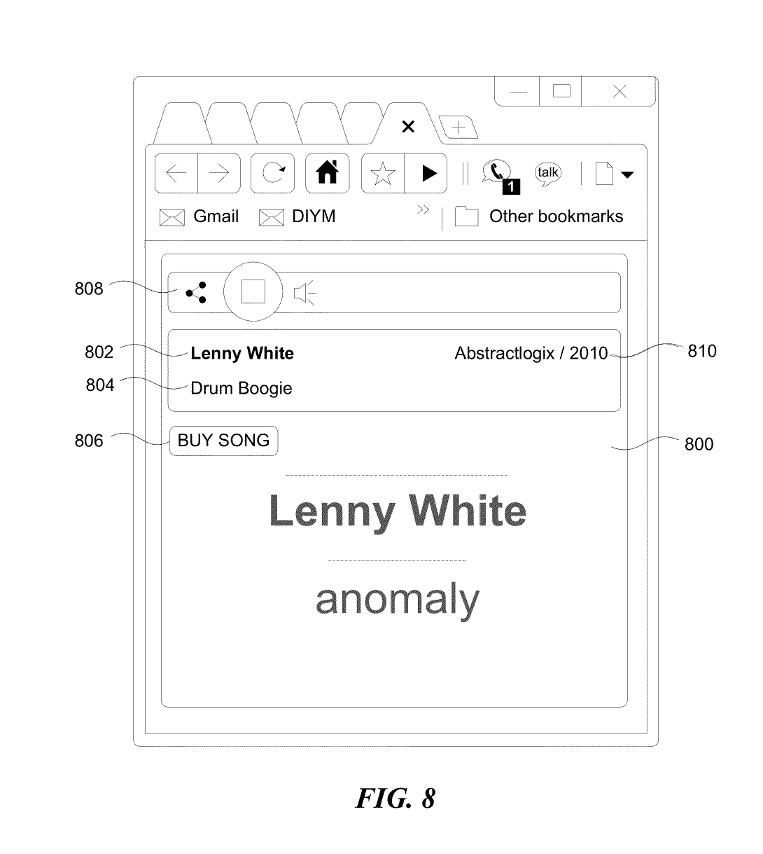

FIG. 8 is an illustration of an activated object 800 in one embodiment. In this embodiment, the object 800 includes a field for the content owner's name 802 (i.e., Lenny White), the name of the musical selection or multimedia content file 804, a buy button 806 which will enable the purchase of the multimedia content, which in this embodiment is the musical selection called “Drum Boogie.” The object 800 also includes a field 810 for the name of the distributor and the year of distribution 2010 (i.e., Abstractlogix/2010) and a field 808 including buttons for limited content previewing and for sharing of the object (see triangular shaped symbol with three dots connected by two lines). Also shown in the field 808 is a play, pause and end-play button. All functionality of the activated object 800 exhibited to a user is performed within a Client executing on a User Device and pointed to the assigned Object URL.

In the present embodiment, the activated object 800 is comprised of a content retrieval component, a content preview component and a transaction processing component. Once activated, the content retrieval component will send a request to the object management service 216 and begin retrieval of the multimedia content file and metadata associated with the object 800 from the cloud-based storage resource 124, the database server 110 or other storage resources which are accessible from the application server 106. Once retrieved, a pre-determined portion of the multimedia content file will be automatically executed by the content preview component to enable the consumer to preview the content prior to making a purchase or licensing decision. In one embodiment, the pre-determined portion is a thirty second audio clip of a musical selection. In an alternative embodiment, the pre-determined portion is a thirty second audio-visual clip of a multimedia content file. If the consumer elects to purchase the multimedia content file, in this embodiment the “Buy Song” button will be clicked on which will cause the execution of the transaction processing component. The transaction processing component will initiate a commercial transaction pertaining to the multimedia content file, which in the present embodiment will involve the licensing of the multimedia content file to the consumer. In an alternative embodiment, the commercial transaction is the purchase of rights to the multimedia content files. In both embodiments, however, the consummation of the commercial transaction will redirect a consumer to a third party web page shown within the activated object 800 where the purchase or license transaction will be completed. In an alternative embodiment, the consumer can specifically pre-designate the vendor that operates the content management platform 200 as an “approved vendor” with the banks and other financial institutions with which he or she maintains credit cards, debit cards or other financial accounts (e.g., checking accounts, savings accounts, trading accounts, etc.). In this embodiment, the activated object 800 will confirm that a purchase or license request has been received and it will execute the purchase or license transaction after receipt of an information signal generated from a single click of a mouse by the consumer on a client device 130, 132, 134 and generate a web page confirming the terms and conditions of the transaction. In an alternative embodiment, the activated object 800 will automatically execute and complete the purchase or license transaction after receipt of an information signal generated from the pressing of a key on a User Device or the reading and registration of a gesture on a touchpad provided on a User Device. In each of these embodiments, once the commercial transaction is completed, all portions of the multimedia content file will be downloaded to the User Device for full execution.

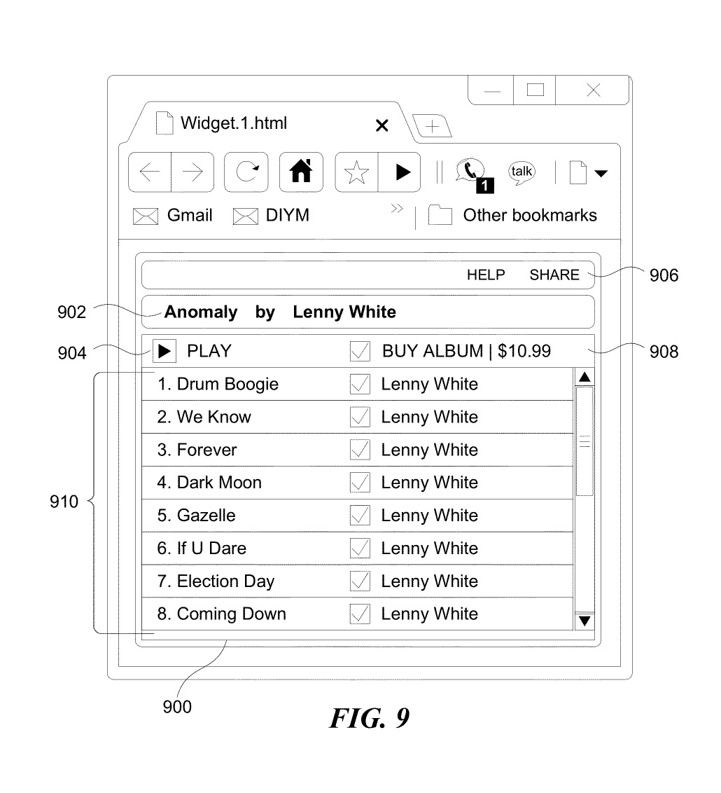

FIG. 9 illustrates an embodiment of an activated object 900 for a release including multiple selections. All of the multimedia content files included in this embodiment of the activated object 900 are illustrated and listed in region 910. In this embodiment, the multimedia content files are musical selections. Additional content files can be previewed using the vertical scroll bar shown on the right side of this illustrated object 900. As shown, there are multiple musical selections by an artist named Lenny White included within the object 900. This embodiment of the object 900 also includes a play button 904 for use in previewing content that has been associated with the object 90 for promotional purposes. In this embodiment, a consumer can select individual content files (i.e., musical selections) and click on the play button 904 to preview the selected files, or click on any content file listed in region 910 to preview only the selected content file. The buy album button 908 is shown in the same row as the play button 904 in this embodiment. In addition, the name of the album 902 (i.e., Anamoly) is shown in the row above the buy button 904 and buy album 908 button. As discussed previously, objects can be virally distributed and shared with third parties which has the effect of increasing the marketing buzz and name recognition for a content owner. This viral distribution capability is enabled by the share link 906, as illustrated in this embodiment, and it permits subsequent distribution of the object 900 to other potential consumers in online social networks or other online communities.

In this alternative embodiment, the activated object 900 is comprised of a content search component, a content retrieval component, a content preview component and a transaction processing component. Once the widget is activated, the consumer is presented with the listing of multimedia content files included in the compilation associated with the object 900. In this illustrative example, the listing includes the songs provided on the “Anomaly” album by Lenny White. In reviewing the listing of the content files, a consumer can elect to preview one or more of the content files. If the consumer selects one or more of the listed multimedia content files associated with the object 900 for previewing, the content search component will be activated and configured to search for the selected multimedia content files, which files are accessible from the application server 106. After the application server 106 locates the content files, the content retrieval component will send a retrieval request to the object management service 216 and the object management service 216 will generate and send a content download request to the application server 106 based on the received retrieval request. After receipt of the content download request from the object management service 216, the application server 106 will commence the retrieval of a pre-determined portion of the selected multimedia content files and associated metadata. Once retrieved, the pre-determined portion of the selected multimedia content files will be automatically executed by the content preview component to enable the consumer to preview the content files prior to making a purchase decision. In one embodiment, the pre-determined portion is a thirty second audio clip of a musical selection. In an alternative embodiment, the pre-determined portion is a thirty second audio-visual clip of a multimedia content file. If the consumer elects to purchase or license the compilation of multimedia content files, which in this embodiment is an album containing multiple multimedia content files, the consumer will click on the “Buy Album” button 908 which will result in the activation of the transaction processing component. The transaction processing component will initiate a commercial transaction pertaining to the multimedia content files resulting in the payment of fees and, in this example, the licensing of the compilation of multimedia content files to the consumer. Once the commercial transaction is complete, all portions of the content files in the compilation will be downloaded to the User Device for full execution.

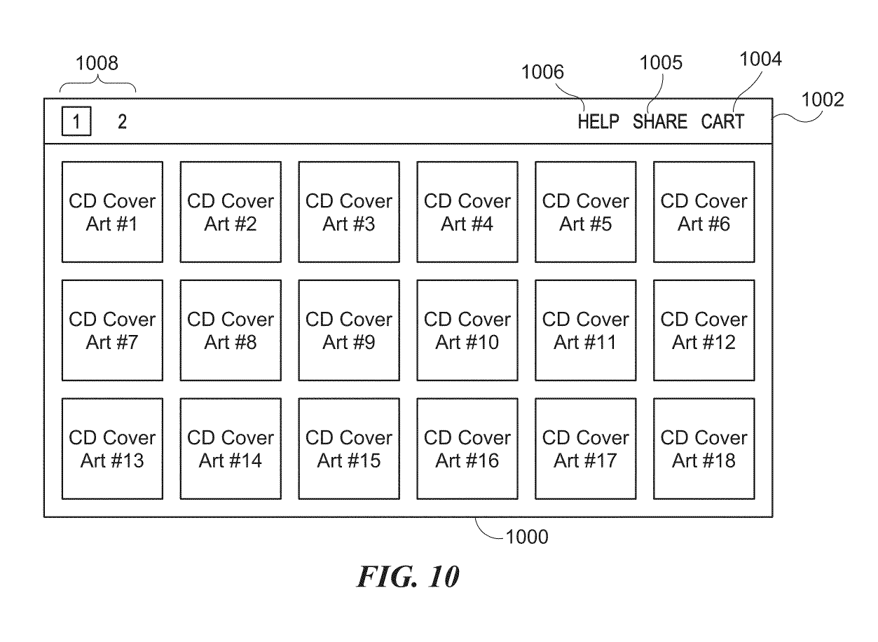

FIG. 10 is an illustration of an activated object for a musical catalog comprised of multiple albums created by a musical artist in an embodiment. The activated catalog object 1000 includes a field 1002 with multiple buttons supporting various functions. As shown in this embodiment, the object 1000 has two pages of content, which pages are accessible by selectable links shown in section 1008. A help button 1006, a cart button 1004 and a share button 1005 are provided to enhance the functionality of the object. Each event occurring on the object including the previewing of content or the sharing of the object 1000 will be monitored by the object tracking service 224 and registered as a recorded event with a NodeID in an Action Graph stored in the database maintained on the database server 110.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A method for tracking social use of portable objects distributed over a computer-communications network, the method comprising:
generating at least one portable object on a content management platform, the content management platform executing on at least one application server, the at least one portable object having an Object Identifier (ObjectID), a unique Universal Resource Locator (URL) and one or more associated content files;
distributing an inactive representation of the at least one portable object over the computer-communications network to one or more network servers, each of the network servers communicatively coupled to a plurality of end-user devices, each end-user device operative to execute one or more Clients, each end-user using the one or more Clients to engage in one or more interactions with an activated portable object associated with each inactive representation of the at least one portable object;
delivering activation data to the one or more Clients after detection of an object activation event on the inactive representation of the at least one portable object, the activation data used in the one or more Clients to execute the activated portable object;
monitoring the one or more interactions between an end-user and the activated portable object after the delivering of the activation data to the one or more Clients; and
storing a record of each of the monitored one or more interactions in a database communicatively coupled to the at least one application server.

2. The method of claim 1 wherein the monitoring of the one or more interactions is performed using an object tracking service of the content management platform.

3. The method of claim 1 wherein the monitoring of the one or more interactions includes monitoring at least one of:
(i) a previewing of content associated with the activated portable object,
(ii) a sharing of the activated portable object with one or more third party end-users,
(iii) a recommending of content associated with the activated portable object;
(iv) a purchasing of content associated with the activated portable object; and
(v) a licensing of content associated with the activated portable object.

4. The method of claim 3 wherein the sharing of the activated portable object with one or more third party end-users causes a distribution of an inactive representation of the activated portable object from the content management platform to each Client executing on each end-user device used by each third party end-user, the inactive representation having an assigned URL including a Proxy User ID of a sharing end-user.

5. The method of claim 4 wherein the sharing of the activated portable object includes posting of the inactive representation to at least one of an online community, an online forum, an online blog and a transmission of the inactive representation in one or more electronic mail messages.

6. The method of claim 4 wherein the sharing of the activated portable object includes posting of the assigned URL to at least one of an online community, an online forum, an online blog and a transmission of the inactive representation in one or more electronic mail messages.

7. The method of claim 1 wherein the plurality of end-user devices includes at least one of a smart phone, a tablet computer, a desktop computer, a laptop computer and a mobile device.

8. The method of claim 1 wherein the one or more Clients includes at least one of a desktop browser and a mobile-device browser.

9. The method of claim 1 wherein the activation data is provided from an object delivery service of the content management platform after receipt of an activation data request.

10. The method of claim 9 wherein the activation data request is transmitted from the one or more Clients to the object delivery service using an interim activation data URL, the interim activation data URL including a domain name, the ObjectID, a Segment Identifier (SegmentID) and a plurality of client-state information.

11. The method of claim 10 wherein the SegmentID and the client-state information include a Proxy User ID, the Proxy User ID being a unique identifier used to identify each end-user of the plurality of end-user devices.

12. The method of claim 11 wherein the Proxy User ID is generated and stored on one or more of the plurality of end-user devices if no Proxy User ID was generated and stored on the one or more end-user devices before the detection of the object activation event.

13. The method of claim 12 wherein the object delivery service redirects the one or more Clients to re-transmit the activation data request to a modified interim activation data URL when the Proxy User ID generated and stored on the one or more end-user devices is not identical to a Proxy User ID associated with the at least one portable object generated on the content management platform.

14. The method of claim 1 wherein the record stored in the database is assigned a unique NodeID, the NodeID representing a collected set of data used to characterize a recorded event, the set of data including at least:
(i) a user agent identification string for each of the one or more Clients;
(ii) a current datetime for each end-user device;
(iii) a connecting internet protocol address for each of the one or more Clients;
(iv) an assigned Proxy User ID; and
(v) an event URL used to associate each of the monitored one or more interactions, a time of occurrence of each of the monitored interactions, and a portable object URL.

15. The method of claim 14 wherein each NodeID is registered in an Action Graph, the Action Graph being a directed graph representing each of the one or more monitored interactions with the activated portable object at each generational level of end-users.

16. The method of claim 1 wherein the object activation event is at least one of a mouse click and a tapping on the inactive representation of the at least one portable object, the tapping performed on a touch-sensitive screen on at least one of the plurality of end-user devices.

17. A system for tracking social use of portable objects distributed over a computer-communications network, the system comprising:
a memory;
a processor coupled to the memory; and
a content management platform stored in the memory, the content management platform operative to:
generate at least one portable object, the at least one portable object having an Object Identifier (ObjectID), a unique Universal Resource Locator (URL) and one or more associated content files;
enable distribution of an inactive representation of the at least one portable object over the computer-communications network to one or more network servers, each of the network servers communicatively coupled to a plurality of end-user devices, each end-user device operative to execute one or more Clients, each end-user using the one or more Clients to engage in one or more interactions with an activated portable object associated with each inactive representation of the at least one portable object;
deliver activation data to the one or more Clients after detection of an object activation event on the inactive representation of the at least one portable object, the activation data used in the one or more Clients to execute the activated portable object;
monitor the one or more interactions between an end-user and the activated portable object after the activation data is delivered to the one or more Clients; and
store a record of each of the monitored one or more interactions in a database on a database server communicatively coupled to the processor.

18. The system of claim 17 wherein the content management platform includes an object tracking service, the object tracking service used to monitor the one or more interactions between the end-user and the activated portable object.

19. The system of claim 17 wherein the one or more interactions the content management platform monitors includes at least one of:
(i) a previewing of content associated with the activated portable object,
(ii) a sharing of the activated portable object with one or more third party end-users,
(iii) a recommending of content associated with the activated portable object;
(iv) a purchasing of content associated with the activated portable object; and
(v) a licensing of content associated with the activated portable object.

20. The system of claim 19 wherein the sharing of the activated portable object with one or more third party end-users causes a distribution of an inactive representation of the activated portable object from the content management platform to each Client executing on each end-user device used by each third party end-user, the inactive representation having an assigned URL including a Proxy User ID of a sharing end-user.

21. The system of claim 20 wherein the sharing of the activated portable object includes posting of the inactive representation to at least one of an online community, an online forum, an online blog and a transmission of the inactive representation in one or more electronic mail messages.

22. The system of claim 20 wherein the sharing of the activated portable object includes posting of the assigned URL to at least one of an online community, an online forum, an online blog and a transmission of the inactive representation in one or more electronic mail messages.

23. The system of claim 17 wherein the plurality of end-user devices includes at least one of a smart phone, a tablet computer, a desktop computer, a laptop computer and a mobile device.

24. The system of claim 17 wherein the one or more Clients includes at least one of a desktop browser and a mobile-device browser.

25. The system of claim 17 wherein the activation data is provided from an object delivery service of the content management platform after receipt of an activation data request.

26. The system of claim 25 wherein the activation data request is transmitted from the one or more Clients to the object delivery service using an interim activation data URL, the interim activation data URL including a domain name, the ObjectID, a Segment Identifier (SegmentID) and a plurality of client-state information.

27. The system of claim 26 wherein the SegmentID and the client-state information include a Proxy User ID, the Proxy User ID being a unique identifier used to identify each end-user of the plurality of end-user devices.

28. The system of claim 27 wherein the Proxy User ID is generated and stored on one or more of the plurality of end-user devices if no Proxy User ID was generated and stored on the one or more end-user devices before the detection of the object activation event.

29. The system of claim 28 wherein the object delivery service redirects the one or more Clients to re-transmit the activation data request to a modified interim activation data URL when the Proxy User ID generated and stored on the one or more end-user devices is not identical to a Proxy User ID associated with the at least one portable object generated on the content management platform.

30. The system of claim 17 wherein the record stored in the database is assigned a unique NodeID, the NodeID representing a collected set of data used to characterize a recorded event, the set of data including at least:
(i) a user agent identification string for each of the one or more Clients;
(ii) a current datetime for each end-user device;
(iii) a connecting internet protocol address for each of the one or more Clients;
(iv) an assigned Proxy User ID; and
(v) an event URL used to associate each of the monitored one or more interactions, a time of occurrence of each of the monitored interactions, and a portable object URL.

31. The system of claim 30 wherein each NodeID is registered in an Action Graph, the Action Graph being a directed graph representing each of the one or more monitored interactions with the activated portable object at each generational level of end-users.

32. The system of claim 17 wherein the object activation event is at least one of a mouse click and a tapping on the inactive representation of the at least one portable object, the tapping performed on a touch-sensitive screen on at least one of the plurality of end-user devices.
